(19) United States
(12) Patent Application Publication
(10) Pub. No.: US 2017/0245264 A1
(43) Pub. Date: Aug. 24, 2017

(54) TERMINAL DEVICE, BASE STATION DEVICE, INTEGRATED CIRCUIT, AND COMMUNICATION METHOD

(71) Applicant: Sharp Kabushiki Kaisha, Sakai City, Osaka (JP)

(72) Inventors: Shoichi SUZUKI, Sakai City, Osaka (JP); Tatsushi AIBA, Sakai City, Osaka (JP); Kazunari YOKOMAKURA, Sakai City, Osaka (JP); Hiroki TAKAHASHI, Sakai City, Osaka (JP)

(73) Assignee: Sharp Kabushiki Kaisha, Sakai City, Osaka (JP)

(21) Appl. No.: 15/518,918

(22) PCT Filed: Aug. 28, 2015
(86) PCT No.: PCT/JP2015/074508

§ 371 Date: Apr. 13, 2017

(30) Foreign Application Priority Data
Oct. 17, 2014 (JP) 2014-212150

(51) Int. Cl. H04W 72/04

(52) U.S. Cl. CPC H04W 72/0413; H04W 72/048; H04W 88/06

(57) ABSTRACT

Provided is a terminal device performing transmission and/or reception in a link between terminal devices. The terminal device transmits third information including first information indicating a band and/or a combination of bands that is supported only when transmission and/or reception is not being performed in the link between the terminal devices and that is used for communication with the base station device, and second information indicating a band and/or a combination of bands that is supported even when transmission and/or reception is being performed in the link between the terminal devices and that is used for communication with the base station device.

### TECHNICAL FIELD

The present invention relates to a terminal device, a base station device, an integrated circuit, and a communication method.

This application claims priority based on Japanese Patent Application No. 2014-212150 filed on Oct. 17, 2014, the contents of which are incorporated herein by reference.

### BACKGROUND ART

In the 3rd Generation Partnership Project (3GPP), a radio access method (Evolved Universal Terrestrial Radio Access (EUTRA)) and a radio access network (Evolved Universal Terrestrial Radio Access Network (EUTRAN)) for cellular mobile communications are being considered. EUTRA and EUTRAN are also referred to as Long Term Evolution (LTE). In LTE, a base station device is also referred to as an evolved NodeB (eNodeB), and a terminal device is also referred to as user equipment (UE). LTE is a cellular communication system in which an area is divided into a plurality of cells to form a cellular pattern, each of the cells being served by a base station device. A single base station device may manage a plurality of cells.

In 3GPP, proximity based services (ProSe) is being considered. ProSe includes ProSe discovery and ProSe communication. ProSe discovery is a process that identifies that a terminal device is in proximity of a different terminal device, using EUTRA. ProSe communication is communication between two terminal devices that are in proximity of each other, through an EUTRAN communication path established between the two terminal devices. For example, the communication path may be established directly between the terminal devices.

ProSe discovery and ProSe communication are also referred to as device to device (D2D) discovery and D2D communication, respectively. Furthermore, ProSe discovery and ProSe communication are collectively referred to as ProSe. Moreover, D2D discovery and D2D communication are collectively referred to as D2D. A communication path is also referred to as a link.

NPL 1 describes that a subset of resource blocks is reserved for D2D, a network configures a set of D2D resources, and a terminal device is allowed to transmit a D2D signal with the configured resources.

### CITATION LIST

### Non-Patent Document

[NON-PATENT DOCUMENT 1] NPL 1: “D2D for LTE Proximity Services: Overview”, R1-132028, 3GPP TSG-RAN WG1 Meeting #73, 20 to 24 May 2013.

### DISCLOSURE OF THE INVENTION

### Problems to be Solved by the Invention

However, sufficient consideration has not been given to a terminal device that performs D2D and cellular communication simultaneously. Some aspects of the present invention have been made in light of the foregoing problem, and an object of the present invention is to provide a terminal device capable of performing D2D efficiently, a base station device controlling the terminal device, an integrated circuit mounted on the terminal device, a base station device used for the base station device, a communication method used by the terminal device, and a communication method used by the base station device.

### Means for Solving the Problems

(1) In order to accomplish the object described above, an aspect of the present invention is contrived to provide the following means. Specifically, a first aspect of the present invention is a terminal device that performs transmission and/or reception in a link between terminal devices. The terminal device includes a transmission unit transmitting first information to a base station device. The first information includes second information and third information. The second information indicates a band and/or a combination of bands that is supported only when transmission and/or reception is not being performed in the link between the terminal devices and that is use for communication with the base station device. The third information indicates a band and/or a combination of bands that is supported even when transmission and/or reception is being performed in the link between the terminal devices and that is used for communication with the base station device.

(2) In the first aspect of the present invention, the second information indicates the number of layers supported for spatial multiplexing in each of the bands indicated by the second information, and the third information indicates the number of layers supported for spatial multiplexing in each of the bands indicated by the third information.

(3) In the first aspect of the present invention, the third information is not recognized by a base station device that is not capable of controlling transmission and/or reception in the link between the terminal devices.

(4) In the first aspect of the present invention, the first information includes fourth information, and the fourth information includes some or all of the following information (A1) to information (A8).
Information (A1): information for requesting a resource for D2D transmission
Information (A2): information indicating a band/frequency for which a resource for D2D transmission is configured
Information (A3): information indicating whether there is an interest in D2D transmission
Information (A4): information indicating a band/frequency for which there is an interest in D2D transmission
Information (A5): information for requesting a resource for D2D reception/monitoring
Information (A6): information indicating a band/frequency for which a resource for D2D reception/monitoring is configured
Information (A7): information indicating whether there is an interest in D2D reception/monitoring
Information (A8): information indicating a band/frequency in which there is an interest in D2D reception/monitoring

(5) In the first aspect of the present invention, the first information includes fifth information corresponding to each of the bands and/or the combinations of bands indicated by the second information, and the fifth information includes some or all of the following information (B1) to information (B6).
Information (B1): information indicating that D2D is possible when the corresponding band or combination of bands is configured for communication with the base station
Information (B2): information indicating that D2D transmission is possible when the corresponding band or combination of bands is configured for communication with the base station
Information (B3): information indicating that D2D reception is possible when the corresponding band or combination of bands is configured for communication with the base station
Information (B4): information indicating a band/frequency in which D2D is possible when the corresponding band or combination of bands is configured for communication with the base station
Information (B5): information indicating a band/frequency in which D2D transmission is possible when the corresponding band or combination of bands is configured for communication with the base station
Information (B6): information indicating a band/frequency in which D2D reception is possible when the corresponding band or combination of bands is configured for communication with the base station

(6) In the first aspect of the present invention, the first information does not include the fifth information corresponding to each of the bands and/or the combinations of bands indicated by the third information.

(7) A second aspect of the present invention is an integrated circuit mounted on a terminal device performing transmission and/or reception in a link between terminal devices. The integrated circuit causes the terminal device to perform a series of functions including the function of transmitting first information to a base station device. The first information includes second information and third information. The second information indicates a band and/or a combination of bands that is supported only when transmission and/or reception is not being performed in the link between the terminal devices and that is used for communication with the base station device. The third information indicates a band and/or a combination of bands that is supported even when transmission and/or reception is being performed in the link between the terminal devices and that is used for communication with the base station device.

(8) A third aspect of the present invention is a communication method used by a terminal device performing transmission and/or reception in a link between terminal devices. The communication method includes the step of transmitting first information to a base station device. The first information includes second information and third information. The second information indicates a band and/or a combination of bands that is supported only when transmission and/or reception is not being performed in the link between the terminal devices and that is used for communication with the base station device. The third information indicates a band and/or a combination of bands that is supported even when transmission and/or reception is being performed in the link between the terminal devices and that is used for communication with the base station device.

(9) A fourth aspect of the present invention is a base station device communicating with a terminal device performing transmission and/or reception in a link between terminal devices. The base station device includes a reception unit receiving first information from the terminal device. The first information includes second information and third information. The second information indicates a band and/or a combination of bands that is supported only when transmission and/or reception is not being performed in the link between the terminal devices and that is used for communication with the base station device. The third information indicates a band and/or a combination of bands that is supported even when transmission and/or reception is being performed in the link between the terminal devices and that is used for communication with the base station device.

(10) In the fourth aspect of the present invention, the second information indicates the number of layers supported for spatial multiplexing in each of the bands indicated by the second information, and the third information indicates the number of layers supported for spatial multiplexing in each of the bands indicated by the third information.

(11) In the fourth aspect of the present invention, the third information is not recognized by a base station device that is not capable of controlling transmission and/or reception in the link between the terminal devices.

(12) In the fourth aspect of the present invention, the third information includes fourth information, and the fourth information includes some or all of the following information (A1) to information (A8).
Information (A1): information for requesting a resource for D2D transmission
Information (A2): information indicating a band/frequency for which a resource for D2D transmission is configured
Information (A3): information indicating whether there is an interest in D2D transmission
Information (A4): information indicating a band/frequency for which there is an interest in D2D transmission
Information (A5): information for requesting a resource for D2D reception/monitoring
Information (A6): information indicating a band/frequency for which a resource for D2D reception/monitoring is configured
Information (A7): information indicating whether there is an interest in D2D reception/monitoring
Information (A8): information indicating a band/frequency for which there is an interest in D2D reception/monitoring

(13) In the fourth aspect of the present invention, the first information includes fifth information corresponding to each of the bands and/or the combinations of bands indicated by the second information, and the fifth information includes some or all of the following information (B1) to information (B6).
Information (B1): information indicating that D2D is possible when the corresponding band or combination of bands is configured for communication with the base station
Information (B2): information indicating that D2D transmission is possible when the corresponding band or combination of bands is configured for communication with the base station
Information (B3): information indicating that D2D reception is possible when the corresponding band or combination of bands is configured for communication with the base station
Information (B4): information indicating a band/frequency in which D2D is possible when the corresponding band or combination of bands is configured for communication with the base station
Information (B5): information indicating a band/frequency in which D2D transmission is possible when the corresponding band or combination of bands is configured for communication with the base station
Information (B6): information indicating a band/frequency in which D2D reception is possible when the corresponding band or combination of bands is configured for communication with the base station

(14) In the fourth aspect of the present invention, the first information does not include the fifth information corresponding to each of the bands and/or the combinations of bands indicated by the third information.

(15) A fifth aspect of the present invention is an integrated circuit mounted on a base station device communicating with a terminal device performing transmission and/or reception in a link between terminal devices. The integrated circuit causes the base station device to perform a series of functions including the function of receiving first information from the terminal device. The first information includes second information and third information. The second information indicates a band and/or a combination of bands that is supported only when transmission and/or reception is not being performed in the link between the terminal devices and that is used for communication with the base station device. The third information indicates a band and/or a combination of bands that is supported even when transmission and/or reception is being performed in the link between the terminal devices and that is used for communication with the base station device.

(16) A sixth aspect of the present invention is a communication method used by a base station device communicating with a terminal device performing transmission and/or reception in a link between terminal devices. The communication method includes the step of receiving first information from the terminal device. The first information includes second information and third information. The second information indicates a band and/or a combination of bands that is supported only when transmission and/or reception is not being performed in the link between the terminal devices and that is used for communication with the base station device. The third information indicates a band and/or a combination of bands that is supported even when transmission and/or reception is being performed in the link between the terminal devices and that is used for communication with the base station device.

### Effects of the Invention

According to some aspects of the present invention, the terminal device can perform D2D efficiently, and the base station device can control the terminal device.

### BRIEF DESCRIPTION OF THE DRAWINGS

FIG. 1 is a conceptual diagram of a radio communication system according to the present embodiment.

FIG. 2 is a schematic block diagram illustrating a configuration of a terminal device 1 according to the present embodiment.

FIG. 3 is a schematic block diagram illustrating a configuration of a base station device 3 according to the present embodiment.

FIG. 4 is a diagram illustrating information/parameters included in RF-Parameters-r10 according to the present embodiment.

FIG. 5 is a diagram illustrating information/parameters included in BandParameters-r10 according to the present embodiment.

FIG. 6 is a diagram illustrating an example of RF-Parameters-r10 according to the present embodiment.

FIG. 7 is a diagram illustrating examples of RF-parameters-r10 and RF-Parameters-r12 according to a first embodiment.

FIG. 8 is a sequence chart relating to transmission of UEcapabilityInformation according to the first embodiment.

FIG. 9 is a diagram illustrating a state in which a terminal device 1A linked to HPLMN and a terminal device 1B linked to VPLMN perform D2D according to a second embodiment.

FIG. 10 is a diagram illustrating examples of RF-parameters-r10 and RF-Parameters-r12 according to the second embodiment.

FIG. 11 is a sequence chart relating to transmission of UEcapabilityInformation according to the second embodiment.

### MODE FOR CARRYING OUT THE INVENTION

Embodiments of the present invention will be described below.

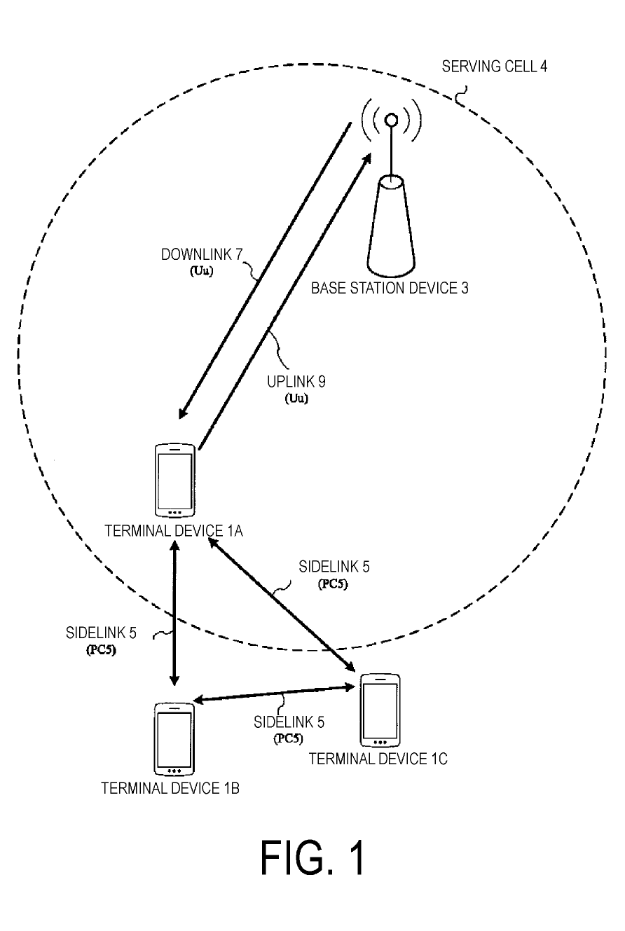

FIG. 1 is a conceptual diagram of the radio communication system according to the present embodiment. In FIG. 1, a radio communication system includes terminal devices 1A to 1C and a base station device 3. The terminal devices 1A to 1C are each referred to as a terminal device 1. A serving cell 4 indicates an area covered by (coverage of) the base station device 3 (LTE or EUTRAN). The terminal device 1A is in-coverage of EUTRAN. The terminal device 1B and the terminal device 1C are out-of-coverage of EUTRAN.

A sidelink 5 is a link between the terminal devices 1. Note that the sidelink 5 may be referred to as a PC5, a D2D communication path, a ProSe link, or a ProSe communication path. In the sidelink 5, D2D discovery and D2D communication are performed. D2D discovery is a process/procedure that identifies that the terminal device 1 is in proximity of a different terminal device, using EUTRA. D2D communication is communication between the plurality of terminal devices 1 that are in proximity of each other, the communication being performed through the EUTRAN communication path established between the plurality of terminal devices 1. For example, the communication path may be established directly between the terminal devices 1.

A downlink 7 is a link from the base station device 3 to the terminal device 1. An uplink 9 is a link from the terminal device 1 to the base station device 3. Note that, in the uplink 9, a signal may be transmitted directly from the terminal device 1 to the base station device 3 without using any repeater. Furthermore, the uplink 5 and the downlink 7 may be collectively referred to as a Uu, a cellular link, or a cellular communication path. Moreover, communication between the terminal device 1 and the base station device 3 may be referred to as cellular communication or communication with EUTRAN.

Physical channels and physical signals according to the present embodiment will be described.

A downlink physical channel and a downlink physical signal are collectively referred to as a downlink signal. An uplink physical channel and an uplink physical signal are collectively referred to as an uplink signal. A D2D physical channel and a D2D physical signal are collectively referred to as a D2D signal. The physical channel is used for transmission of information output from a higher layer. The physical signal is not used for transmission of the information output from the higher layer but is used by the physical layer.

In FIG. 1, the following D2D physical channels are used in the radio communication in the D2D links 9 between the terminal devices 1.
Physical sidelink broadcast channel (PSBCH)
Physical sidelink control channel (PSCCH)
Physical sidelink shared channel (PSSCH)
Physical sidelink discovery channel (PSDCH)

The PSBCH is used for transmission of information indicating a frame number for D2D. The PSCCH is used for transmission of sidelink control information (SCI). The SCI is used for scheduling of the PSSCH. The PSSCH is used for transmission of D2D communication data, namely sidelink shared channel (SL-SCH). The PSDCH is used for transmission of D2D discovery data, namely sidelink discovery channel (SL-DCH).

In FIG. 1, the following D2D physical signals are used in D2D radio communication.
Sidelink synchronization signal
Sidelink demodulation reference signal

From the viewpoint of the terminal device 1 that performs transmission, the terminal device 1 can operate in two modes (mode 1 and mode 2) for resource allocation in D2D communication.

In mode 1, EUTRAN (base station device 3) schedules specific resources to be used by the terminal device 1 to transmit a communication signal (D2D data and D2DSA).

In mode 2, the terminal device 1 selects resources from a resource pool for transmission of a communication signal (D2D data and D2DSA). The resource pool is a set of resources. The resource pool for mode 2 may be configured/restricted in a semi-static manner by EUTRAN (base station device 3). Alternatively, the resource pool for mode 2 may be pre-configured.

The terminal device 1 that is capable of D2D communication and is in-coverage of EUTRAN may support mode 1 and mode 2. The terminal device 1 that is capable of D2D communication and is out-of-coverage of EUTRAN may support mode 2 only.

Two types (type 1 and type 2) of D2D discovery procedure are defined.

The D2D discovery procedure of type 1 is a D2D discovery procedure in which resources for discovery signals are not allocated individually to the terminal devices 1. In other words, in the D2D discovery procedure of type 1, resources for discovery signals may be allocated to all the terminal devices 1 or a group of the terminal devices 1.

The D2D discovery procedure of type 2 is a D2D discovery procedure in which resources for discovery signals are allocated individually to the terminal devices 1. The discovery procedure in which resources are allocated individually to transmission instances of discovery signals is referred to as a type 2A discovery procedure. A discovery procedure of type 2 in which resources are semi-persistently allocated for transmission of discovery signals is referred to as a type 2B discovery procedure.

In FIG. 1, the following uplink physical channels are used in the uplink radio communication.
Physical uplink control channel (PUCCH)
Physical uplink shared channel (PUSCH)
Physical random access channel (PRACH)

In FIG. 1, the following uplink physical signal is used in the uplink radio communication.
Uplink reference signal (UL RS)

In FIG. 1, in the downlink radio communication, the following downlink physical channels are used.
Physical broadcast channel (PBCH)
Physical control format indicator channel (PCFICH)
Physical hybrid automatic repeat request indicator channel (PHICH)
Physical downlink control channel (PDCCH)
Enhanced physical downlink control channel (EPDCCH)
Physical downlink shared channel (PDSCH)
Physical multicast channel (PMCH)

In FIG. 1, in the downlink radio communication, the following downlink physical signals are used.
Synchronization signal (SS)
Downlink reference signal (DL RS)

The SL-SCH and the SL-DCH are transport channels. The PUSCH, the PBCH, the PDSCH, and the PMCH are used for carrying a transport channel. A channel used in a medium access control (MAC) layer is referred to as a transport channel. The unit of data on the transport channel used in the MAC layer is referred to as a transport block (TB) or a MAC protocol data unit (PDU). Control of a hybrid automatic repeat request (HARD) is performed on each transport block in the MAC layer. The transport block is a unit of data that the MAC layer delivers to the physical layer. In the physical layer, the transport block is mapped to a codeword, and coding processing is performed on a codeword-by-codeword basis.

A configuration of a device according to the present embodiment will be described below.

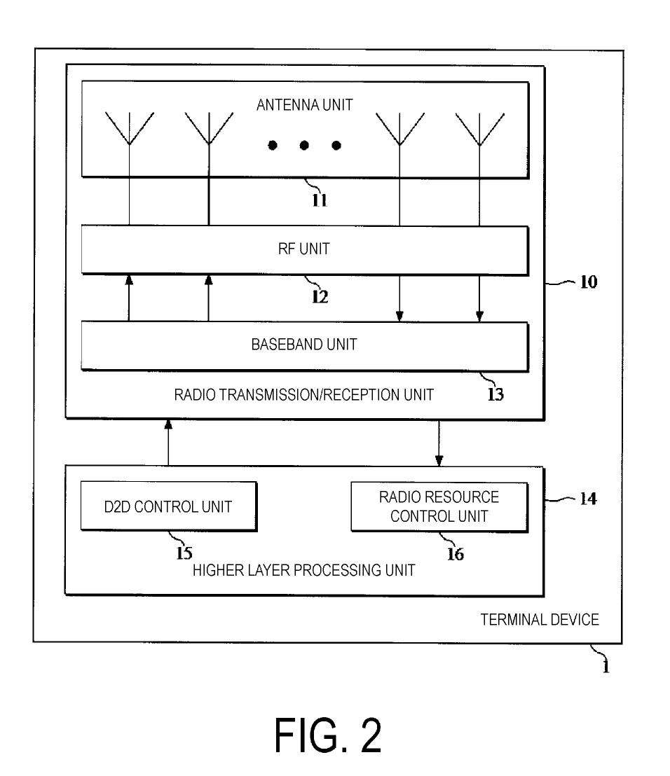

FIG. 2 is a schematic block diagram illustrating a configuration of the terminal device 1 according to the present embodiment. As illustrated in FIG. 2, the terminal device 1 is configured to include a radio transmission/reception unit 10 and a higher layer processing unit 14. The radio transmission/reception unit 10 is configured to include an antenna unit 11, a radio frequency (RF) unit 12, and a baseband unit 13. The higher layer processing unit 14 is configured to include a D2D control unit 15 and a radio resource control unit 16. The radio transmission/reception unit 10 is also referred to as a transmission unit or a reception unit.

The higher layer processing unit 14 outputs uplink data (transport block) generated by a user operation or the like, to the radio transmission/reception unit 10. The higher layer processing unit 14 performs processing of the medium access control (MAC) layer, the packet data convergence protocol (PDCP) layer, the radio link control (RLC) layer, and the radio resource control (RRC) layer.

The radio resource control unit 16 included in the higher layer processing unit 14 manages various configuration information/parameters of the terminal device 1 itself. The radio resource control unit 16 sets the various configuration information/parameters in accordance with a higher layer signal received from the base station device 3. Specifically, the radio resource control unit 16 sets the various configuration information/parameters in accordance with the information indicating the various configuration information/parameters received from the base station device 3.

The D2D control unit 15 included in the higher layer processing unit 14 controls D2D discovery and/or D2D communication in accordance with the various configuration information/parameters managed by the radio resource control unit 16. The D2D control unit 15 may generate information associated with D2D to be transmitted to a different terminal device 1 or EUTRAN (base station device 3). The D2D control unit 15 manages information indicating whether there is an interest in transmission of D2D discovery, reception/monitoring of D2D discovery, transmission of D2D communication, and/or reception/monitoring of D2D communication.

The radio transmission/reception unit 10 performs processing of the physical layer, such as modulation, demodulation, coding, and decoding. The radio transmission/reception unit 10 demultiplexes, demodulates, and decodes a signal received from the base station device 3, and outputs the information resulting from the decoding to the higher layer processing unit 14. The radio transmission/reception unit 10 modulates and codes data to generate a transmit signal, and transmits the transmit signal to the base station device 3.

The RF unit 12 converts (down-converts) a signal received through the antenna unit 11 into a baseband signal by orthogonal demodulation and removes unnecessary frequency components. The RF unit 12 outputs the processed analog signal to the baseband unit.

The baseband unit 13 converts the analog signal input from the RF unit 12 into a digital signal. The baseband unit 13 removes a portion corresponding to a cyclic prefix (CP) from the digital signal resulting from the conversion, performs fast Fourier transform (FFT) on the signal from which the CP has been removed, and extracts a signal in the frequency domain.

The baseband unit 13 performs inverse fast Fourier transform (IFFT) on data, generates an SC-FDMA symbol, attaches a CP to the generated SC-FDMA symbol, generates a digital signal in a baseband, and converts the digital signal in the baseband into an analog signal. The baseband unit 13 outputs the analog signal resulting from the conversion, to the RF unit 12.

The RF unit 12 removes unnecessary frequency components from the analog signal input from the baseband unit 13 using a low-pass filter, up-converts the analog signal into a signal of a carrier frequency, and transmits the final result via the antenna unit 11.

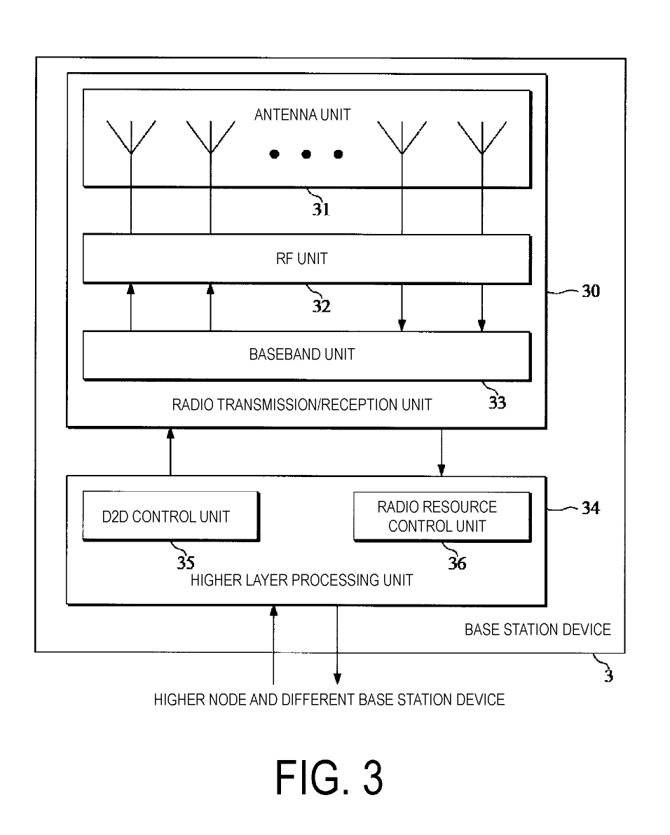

FIG. 3 is a schematic block diagram illustrating a configuration of the base station device 3 according to the present embodiment. As illustrated in FIG. 3, the base station device 3 is configured to include a radio transmission/reception unit 30 and a higher layer processing unit 34. The radio transmission/reception unit 30 is configured to include an antenna unit 31, an RF unit 32, and a baseband unit 33. The higher layer processing unit 34 is configured to include a D2D control unit 35 and a radio resource control unit 36. The radio transmission/reception unit 30 is also referred to as a transmission unit or a reception unit.

The higher layer processing unit 34 performs processing of the medium access control (MAC) layer, the packet data convergence protocol (PDCP) layer, the radio link control (RLC) layer, and the radio resource control (RRC) layer.

The D2D control unit 35 included in the higher layer processing unit 34 controls D2D discovery and/or D2D communication in the terminal device 1 communicating through a cellular link, in accordance with the various configuration information/parameters managed by the radio resource control unit 36. The D2D control unit 35 may generate information associated with D2D to be transmitted to a different base station device 3 and/or the terminal device 1.

The radio resource control unit 36 included in the higher layer processing unit 34 generates, or acquires from a higher node, downlink data (transport block) arranged on a physical downlink channel, system information, an RRC message, a MAC control element (CE), and the like, and outputs the generated or acquired data to the radio transmission/reception unit 30. Furthermore, the radio resource control unit 36 manages various configuration information/parameters for each of the terminal devices 1. The radio resource control unit 36 may set various configuration information/parameters for each of the terminal devices 1 via a higher layer signal. In other words, the radio resource control unit 36 transmits/broadcasts information indicating various configuration information/parameters.

The capability of the radio transmission/reception unit 30 is similar to that of the radio transmission/reception unit 10, and hence description thereof is omitted.

In the present embodiment, one or a plurality of cells are configured for the terminal device 1. A technology in which the terminal device 1 communicates with the base station device 3 via a plurality of cells is referred to as carrier aggregation. Each of the cells configured for the terminal device 1 is referred to as a serving cell. The serving cell is used for EUTRAN communication.

The configured plurality of serving cells include one primary cell and one or a plurality of secondary cells. The primary cell is a serving cell in which an initial connection establishment procedure has been performed, a serving cell in which a connection re-establishment procedure has been started, or a cell indicated as a primary cell during a handover procedure. At the point of time when a radio resource control (RRC) connection is established, or later, a secondary cell may be configured.

For cell aggregation, a time division duplex (TDD) scheme or a frequency division duplex (FDD) scheme may be applied to all the plurality of cells. Cells to which the TDD scheme is applied and cells to which the FDD scheme is applied may be aggregated.

However, the capability of the radio transmission/reception unit 10 varies among the terminal devices 1. In other words, the band (carrier, frequency) combination to which carrier aggregation is applicable varies among the terminal devices 1. For this reason, each of the terminal devices 1 transmits information/parameter RF-Parameters-r10 indicating the band combination to which carrier aggregation is applicable, to the base station device 3. Hereinafter, the band to which carrier aggregation is applicable is also referred to as a CA band. A band to which carrier aggregation is not applicable or a band to which carrier aggregation is applicable but is not applied is also referred to as a non-CA band.

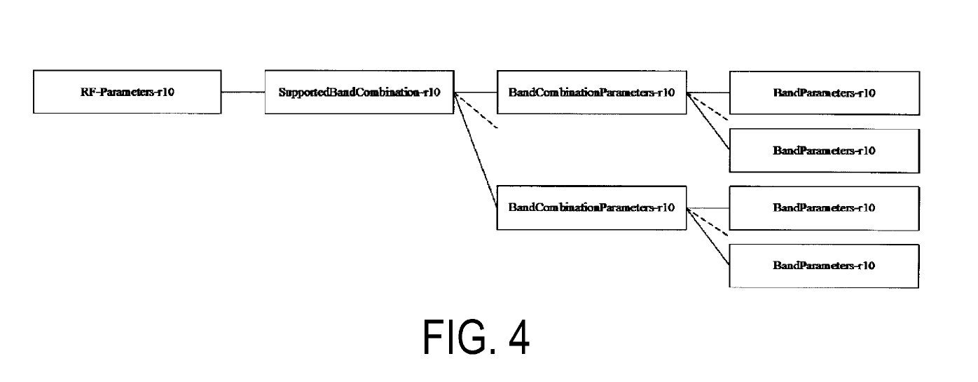

FIG. 4 is a diagram illustrating information/parameters included in RF-Parameters-r10 according to the present embodiment. RF-Parameters-r10 includes one SupportedBandCombination-r10. SupportedBandCombination-r10 includes one or a plurality of BandCombinationParameters-r10.

SupportedBandCombination-r10 includes a supported CA band combination and a supported non-CA band.

BandCombinationParameters-r10 includes one or a plurality of BandParameters-r10. Each BandCombinationParameters-r10 indicates a supported CA band combination or a supported non-CA band. For example, when BandCombinationParameters-r10 includes a plurality of BandParameters-r10, communication to which carrier aggregation with the combination of CA bands indicated by the plurality of BandParameters-r10 is applied is supported. When BandCombinationParameters-r10 includes one BandParameters-r10, communication in the band (non-CA band) indicated by the one BandParameters-r10 is supported.

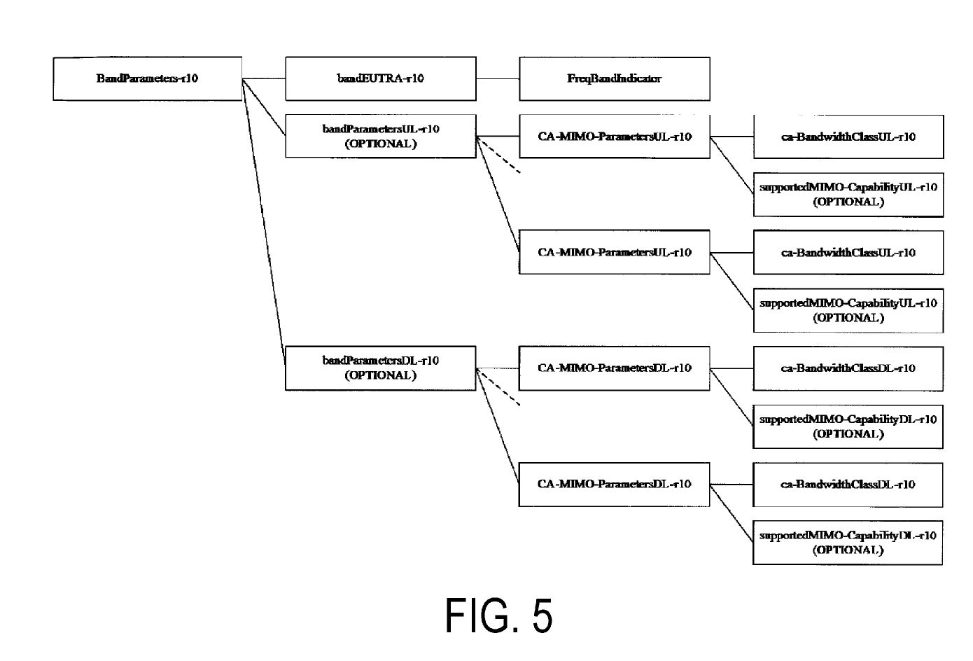

FIG. 5 is a diagram illustrating information/parameters included in BandParameters-r10 according to the present embodiment. BandParameters-r10 includes bandEUTRA-r10, bandParametersUL-r10, and bandParametersDL-r10.

bandEUTRA-r10 includes FreqBandIndicator. FreqBandIndicator indicates a band. When the terminal device 1 is not capable of transmitting an uplink signal in the band indicated by FreqBandIndicator, BandParameters-r10 does not include bandParametersUL-r10. When the terminal device 1 is not capable of receiving a downlink signal in the band indicated by FreqBandIndicator, BandParameters-r10 does not include bandParametersDL-r10.

bandParametersUL-r10 includes one or a plurality of CA-MIMO-ParametersUL-r10. CA-MIMO-ParametersUL-r10 includes ca-BandwidthClassUL-r10 and supportedMIMO-CapabilityUL-r10. ca-BandwidthClassUL-r10 includes CA-BandwidthClass-r10.

supportedMIMO-CapabilityUL-r10 indicates the number of layers supported for spatial multiplexing in the uplink. When spatial multiplexing is not supported in the uplink, CA-MIMO-ParametersUL-r10 does not include supportedMIMO-CapabilityUL-r10.

bandParametersDL-r10 includes one or a plurality of CA-MIMO-ParametersDL-r10. CA-MIMO-ParametersDL-r10 includes ca-BandwidthClassDL-r10 and supportedMIMO-CapabilityDL-r10. ca-BandwidthClassDL-r10 includes CA-BandwidthClass-r10.

supportedMIMO-CapabilityDL-r10 indicates the number of layers supported for spatial multiplexing in the downlink. When spatial multiplexing is not supported in the downlink, CA-MIMO-ParametersDL-r10 does not include supportedMIMO-CapabilityUL-r10.

CA-BandwidthClass-r10 indicates the CA bandwidth class supported by the terminal device 1 in the uplink or the downlink. CA-BandwidthClassUL-r10 corresponds to the CA bandwidth class supported by the terminal device 1 in the uplink. CA-BandwidthClassDL-r10 corresponds to the CA bandwidth class supported by the terminal device 1 in the downlink. Each of the CA bandwidth classes is defined by the number of cells that can be simultaneously configured by the terminal device 1 in the band indicated by FreqBandIndicator, the total of the bandwidths of the cells simultaneously configured in the band indicated by FreqBandIndicator, and the like. For example, a CA bandwidth class a indicates that a single cell of 20 MHz or lower is configurable.

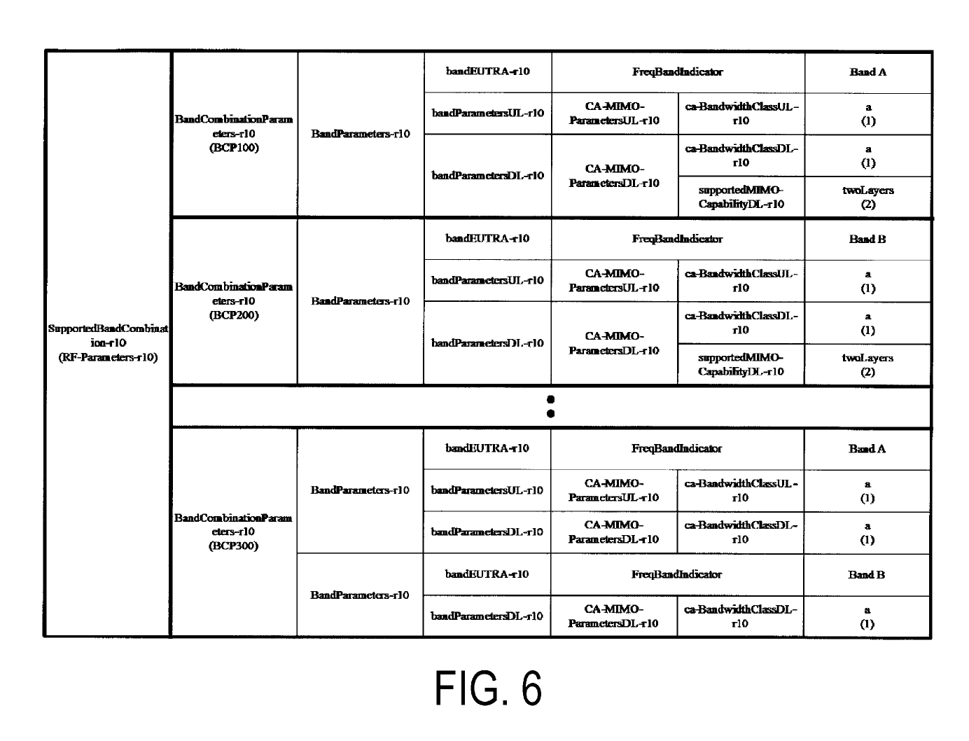

FIG. 6 is a diagram illustrating an example of RF-Parameters-r10 according to the present embodiment. For example, RF-Parameters-r10 includes one SupportedBandCombination-r10. As described above, SupportedBandCombination-r10 includes one or a plurality of BandCombinationParameters-r10. BandCombinationParameters-r10 includes one or a plurality of BandParameters-r10.

BandCombinationParameters-r10 of BCP100 indicates that uplink transmission is possible in a single cell in Band A and that downlink transmission is possible in a single cell in Band A. In other words, BandCombinationParameters-r10 of BCP100 indicates that a single cell is supported in Band A. BandCombinationParameters-r10 of BCP100 indicates that two layers are supported for spatial multiplexing in the downlink in Band A. BandCombinationParameters-r10 of BCP100 indicates that spatial multiplexing is not supported in the uplink in Band A.

BandCombinationParameters-r10 of BCP300 indicates that uplink transmission is possible in a single cell in Band A, that downlink transmission is possible in a single cell in Band A, and that downlink transmission is possible in a single cell in Band B. In other words, BandCombinationParameters-r10 of BCP100 indicates that a combination of a single primary cell in Band A and a single secondary cell in Band B without an uplink is supported. BandCombinationParameters-r10 of BCP300 indicates that the spatial multiplexing in the downlink in Band A, the spatial multiplexing in the downlink in Band B, and the spatial multiplexing in the uplink in Band A are not supported.

A method of configuring a D2D resource according to the present embodiment will be described.

A resource reserved for D2D is referred to as a D2D resource. In an FDD cell, a downlink signal to be used for cellular communication is mapped to subframes of the downlink carrier, an uplink signal to be used for cellular communication is mapped to subframes of the uplink carrier, and a D2D signal to be used for D2D is mapped to subframes of the uplink carrier. A carrier corresponding to a cell in the downlink is referred to as a downlink component carrier. A carrier corresponding to a cell in the uplink is referred to as an uplink component carrier. A TDD carrier is a downlink component carrier and is also an uplink component carrier.

In a TDD cell, a downlink signal to be used for cellular communication is mapped to downlink subframes and DwPTS, an uplink signal to be used for cellular communication is mapped to uplink subframes and UpPTS, and a D2D signal to be used for D2D is mapped to uplink subframes.

An FDD subframe including a D2D resource and a TDD uplink subframe including a D2D resource are each also referred to as a sidelink subframe.

The base station device 3 controls D2D resources reserved for D2D. The base station device 3 reserves some of the resources of the uplink carrier in the FDD cell, as D2D resources. The base station device 3 may reserve some of the resources in the uplink subframes and UpPTS in the TDD cell, as D2D resources.

The base station device 3 may transmit a higher layer signal including information indicating a set (pool) of D2D resources reserved in each of the cells, to the terminal device 1. The terminal device 1 sets a parameter D2D-ResourceConfig indicating the D2D resources reserved in each of the cells, in accordance with the higher layer signal received from the base station device 3. In other words, the base station device 3 may set the parameter D2D-ResourceConfig indicating the D2D resources reserved in each of the cells, for the terminal device 1 via the higher layer signal.

The base station device 3 may set one or a plurality of parameters indicating one or a plurality of sets of resources reserved for D2D, for the terminal device 1 via the higher layer signal.

Sets of D2D resources for D2D discovery type 1, D2D discovery type 2, D2D communication mode 1, and D2D communication mode 2 may be configured individually.

Resource sets for D2D physical channels may be configured individually.

Resource sets for D2D transmission and reception may be configured individually.

A resource set for PSSCH relating to D2D data transmission and a resource set for the PSCCH relating to SCI transmission may be configured individually.

From the viewpoint of the terminal device 1, some of the above-described resource sets may be transparent. For example, the PSSCH in D2D communication mode 1 is scheduled in accordance with the SCI, which eliminates the need for the terminal device 1 to configure any resource set for receiving/monitoring the PSSCH in D2D communication mode 1.

3GPP has been considering the use of D2D for public safety (PS). The base station device 3 may notify the terminal device 1 of whether each set of D2D resources is a set of resources for PS. The terminal device 1 may be authorized, via EUTRAN, to perform D2D for PS. In other words, the terminal device 1 that is not authorized to perform D2D for PS is not allowed to perform D2D with a set of resources for PS.

The terminal device 1 may have a configuration relating to D2D configured in advance. When the terminal device 1 fails to detect any cell at the carrier/frequency for which D2D is authorized, the terminal device 1 may perform D2D communication/D2D discovery in accordance with the configuration configured in advance. In other words, when the terminal device 1 is out-of-coverage of EUTRAN at the carrier/frequency for which D2D is authorized, the terminal device 1 may perform D2D communication/D2D discovery at the carrier/frequency for which D2D is authorized, in accordance with the configuration configured in advance. In other words, the terminal device 1 may perform D2D transmission and/or communication at the frequency/carrier for which no serving cell is configured.

When the terminal device 1 is out-of-coverage of EUTRAN at the carrier/frequency for which D2D is authorized, the terminal device 1 may simultaneously perform D2D communication/D2D discovery at the carrier/frequency for which D2D is authorized, in accordance with the configuration configured in advance, and cellular communication at a carrier/frequency for which D2D is not authorized.

The function of the radio transmission/reception unit 10 of the terminal device 1 may be shared between the cellular link and the sidelink. For example, the function of the radio transmission/reception unit 10 for the cellular link may be partially used for the sidelink. For example, when D2D is not being performed, the function of the radio transmission/reception unit 10 for the sidelink may be used for the cellular link.

A first embodiment will be described below. The first embodiment may be applied to any one or both of D2D communication and D2D discovery. The first embodiment may be applied only to sidelink transmission and cellular link transmission. The first embodiment may be applied only to sidelink reception and cellular link reception.

Possible combinations of one or a plurality of bands in the cellular link and a band in the sidelink varies in a manner that depends on the configuration of the radio transmission/reception unit 10 of the terminal device 1. For example, when two cells in Band A are simultaneously configured in the cellular link, a certain terminal device 1 is able to perform D2D in Band B, but when two cells in Band A and one cell in Band B are simultaneously configured in the cellular link, the terminal device 1 may be unable to perform D2D in Band B. In other words, when no cell is configured in Band B for the cellular link, a certain terminal device 1 is able to perform D2D in Band B, but when at least one cell is configured in Band B for the cellular link, the terminal device 1 may be unable to perform D2D in Band B.

To address this, in the first embodiment, information/parameter ProSeAssistance-r12 indicating the D2D configuration and/or interest of the terminal device 1 and information/parameter RF-Parameters-r12 indicating D2D capability in corresponding BandCobinationParameter-r10 are transmitted together with information/parameter RF-parameters-r10.

Information/parameter ProSeAssistance-r12 may include some or all of the following information (1) to information (8). Information for D2D communication and information for D2D discovery may be separated from each other. In other words, information for D2D communication and information for D2D discovery may be distinguished from each other. To be more specific, the following information (1) to information (8) may be defined for D2D communication. Furthermore, the following information (1) to information (8) may be defined for D2D discovery. Some of information (1) to information (8) may be brought together to define a single piece of information.
Information (1): information for requesting a resource for D2D transmission
Information (2): information indicating a band/frequency in which a resource for D2D transmission is configured
Information (3): information indicating whether there is an interest in D2D transmission
Information (4): information indicating a band/frequency in which there is an interest in D2D transmission
Information (5): information for requesting a resource for D2D reception/monitoring
Information (6): information indicating a band/frequency in which a resource for D2D reception/monitoring is configured
Information (7): information indicating whether there is an interest in D2D reception/monitoring
Information (8): information indicating a band/frequency in which there is an interest in D2D reception/monitoring

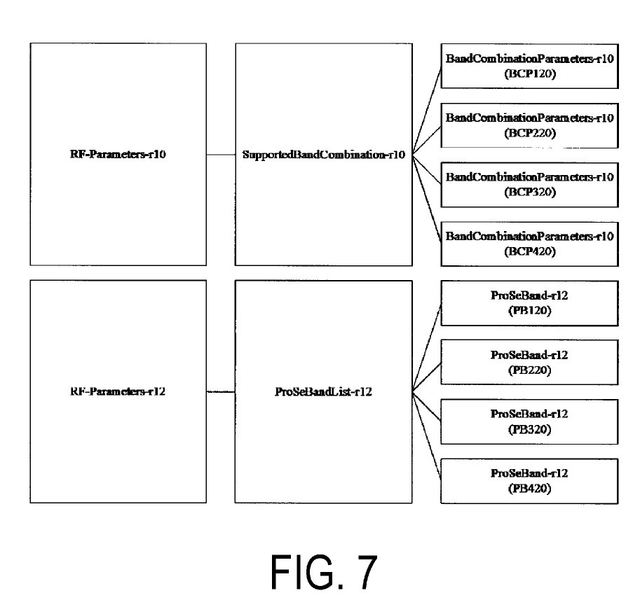

FIG. 7 is a diagram illustrating examples of RF-parameters-r10 and RF-Parameters-r12 according to the first embodiment. In FIG. 7, RF-parameters-r10 includes SupportedBandCombination-r10, and SupportedBandCombination-r10 includes four BandCobinationParameter-r10 (BCP120, BCP220, BCP320, and BCP420). RF-parameters-r12 includes ProSeBandList-r12, and ProSeBandList-r12 includes ProSeBand-r12 (PB120, PB220, PB320, and PB420). Here, the number of ProSeBand-r12 included in ProSeBandList-r12 is the same as the number of BandCobinationParameter-r10 (four) included in SupportedBandCombination-r10. In other words, one ProSeBand-r12 corresponds to one BandCobinationParameter-r10. For example, the order of ProSeBand-r12 is the same as the order of the corresponding BandCobinationParameter-r10. In other words, PBX20 corresponds to BCPX20 (X=1, 2, 3, or 4).

Information/parameter ProSeBand-r12 may include some or all of the following information (9) to information (14). Information for D2D communication and information for D2D discovery may be separated from each other. In other words, information for D2D communication and information for D2D discovery may be distinguished from each other. To be more specific, the following information (9) to information (14) may be defined for D2D communication. The following Information (9) to information (14) may be defined for D2D discovery. Some of information (9) to information (14) may be brought together to define a single piece of information.
Information (9): information indicating that D2D is possible when a band/the number of layers or a combination of bands/the number of layers indicated by the corresponding BandCobinationParameter-r10 is configured for the cellular link
Information (10): information indicating that D2D transmission is possible when a band/the number of layers or a combination of bands/the number of layers indicated by the corresponding BandCobinationParameter-r10 is configured for the cellular link
Information (11): information indicating that D2D reception is possible when a band/the number of layers or a combination of bands/the number of layers indicated by the corresponding BandCobinationParameter-r10 is configured for the cellular link
Information (12): information indicating a band/frequency in which D2D is possible when a band/the number of layers or a combination of bands/the number of layers indicated by the corresponding BandCobinationParameter-r10 is configured for the cellular link
Information (13): information indicating a band/frequency in which D2D transmission is possible when a band/the number of layers or a combination of bands/the number of layers indicated by the corresponding BandCobinationParameter-r10 is configured for the cellular link
Information (14): information indicating a band/frequency in which D2D reception is possible when a band/the number of layers or a combination of bands/the number of layers indicated by the corresponding BandCobinationParameter-r10 is configured for the cellular link

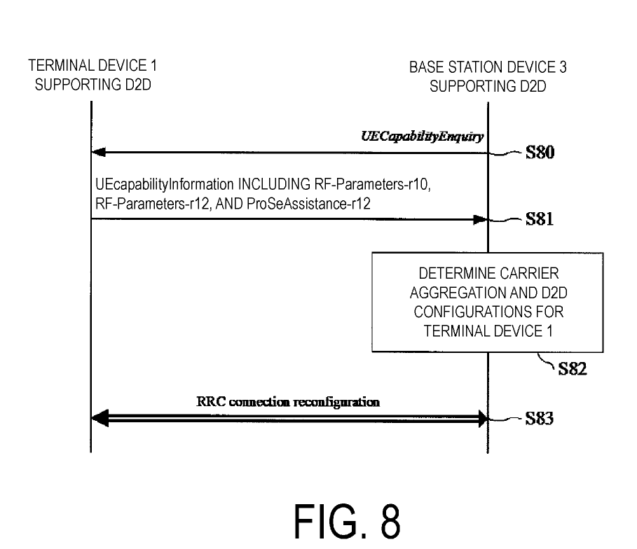

FIG. 8 is a sequence chart relating to the transmission of UEcapabilityInformation according to the first embodiment. UEcpabilityInformation may be an RRC message.

The base station device 3 supporting D2D transmits information/parameter UECapabilityEnquitry for requesting transmission of information/parameter UEcapabilityInformation, to the terminal device 1 supporting either or both of D2D communication and D2D discovery (S80). A base station device supporting D2D is referred to simply as the base station device 3 below. The terminal device 1 supporting either or both of D2D communication and D2D discovery is simply referred to as the terminal device 1 below.

The terminal device 1 that has received information/parameter UECapabilityEnquitry transmits UEcapabilityInformation including ProSeAssistance-r12, RF-Parameters-r10, and RF-parameters-r12, to the base station device 3 (S81). In accordance with the received UEcapabilityInformation, the base station device 3 determines the configuration for carrier aggregation and/or spatial multiplexing, and D2D communication and/or D2D discovery for the terminal device 1 (S82). In accordance with the configuration determined in S82, the base station device 3 performs RRC connection reconfiguration for the terminal device 1 (S83).

These processes allow the base station device 3 to efficiently configure D2D and cells in the cellular link, on the basis of whether the terminal device 1 has an interest in D2D and the capability of the radio transmission/reception unit 10 of the terminal device 1. Moreover, these processes allow the terminal device 1 to simultaneously perform D2D communication, D2D discovery and/or cellular communication efficiently.

A second embodiment will be described below. The second embodiment may be applied to any one or both of D2D communication and D2D discovery.

The second embodiment may be applied only to sidelink transmission and cellular link transmission. The second embodiment may be applied only to sidelink reception and cellular link reception.

When the band combination/band indicated by BandCobinationParameter-r10 is configured in a cellular link, the terminal device 1 according to the second embodiment includes BandCobinationParameter-r10 in SupportedBandCombination-r10 or SupportedBandCombinationExt-r12 on the basis of whether sidelink transmission/reception is possible.

In other words, when sidelink transmission/reception is configured, the terminal device 1 according to the second embodiment includes BandCobinationParameter-r10 in SupportedBandCombination-r10 or SupportedBandCombinationExt-r12, on the basis of whether configuration of the combination of bands/the band/the number of layers indicated by BandCobinationParameter-r10 is possible in the cellular link.

When the combination of bands/the band/the number of layers indicated by BandCobinationParameter-r10 is configured in the cellular link, the terminal device 1 according to the second embodiment may include BandCobinationParameter-r10 in SupportedBandCombination-r10 or SupportedBandCombinationExt-r12, on the basis of whether sidelink transmission/reception is possible in a band other than the band indicated by BandCobinationParameter-r10.

In other words, when sidelink transmission/reception is configured in a band other than the band indicated by BandCobinationParameter-r10, the terminal device 1 according to the second embodiment may include BandCobinationParameter-r10 in SupportedBandCombination-r10 or SupportedBandCombinationExt-r12, on the basis of whether configuration of the combination of bands/the band/the number of layers indicated by BandCobinationParameter-r10 is possible in the cellular link.

Note that the combination of bands/the band/the number of layers indicated by BandCobinationParameter-r10 included in SupportedBandCombination-r10 does not coincide with the combination of bands/the band/the number of layers indicated by BandCobinationParameter-r10 included in SupportedBandCombinationExt-r12.

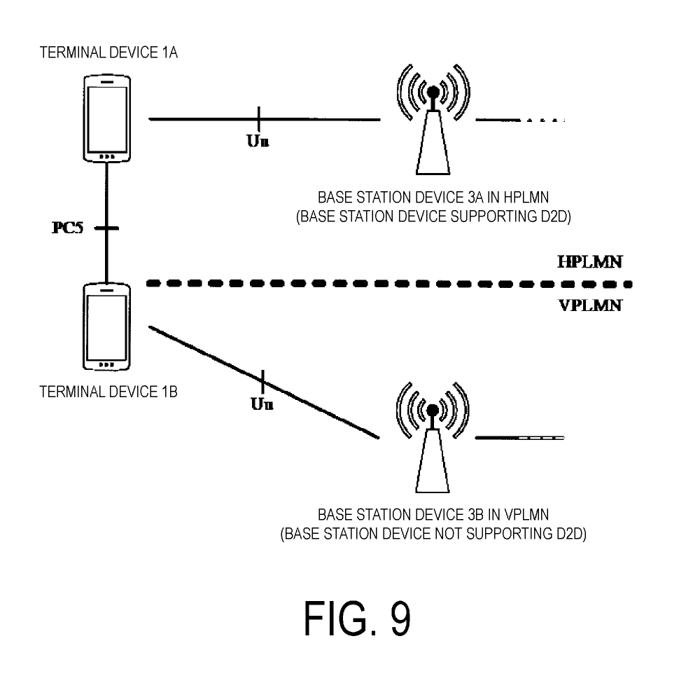

FIG. 9 is a diagram illustrating a state in which a terminal device 1A linked to a home public land mobile network (HPLMN) and a terminal device 1B linked to a visited public land mobile network (VPLMN) perform D2D according to the second embodiment. In FIG. 9, the HPLMN supports D2D, while the VPLMN does not support D2D. In FIG. 9, the terminal device 1A and the terminal device 1B perform D2D at the carrier/frequency authorized in the HPLMN.

In FIG. 9, the terminal device 1B roaming in the VPLMN performs D2D at the carrier/frequency authorized in the HPLMN. This means that, in FIG. 9, any CA band combination not supporting D2D is not configurable among the combinations of CA bands transmitted by the terminal device 1B using RF-parameters-r10. However, the VPLMN does not support D2D, which causes neither ProSeAssistance-r12 nor RF-parameters-r12 to be identified. Hence, there is a problem that an attempt is made to configure a CA band combination not supporting D2D, in accordance with RF-parameters-r10.

To address this, in the second embodiment, SupportedBandCombination-r10 may include a combination of CA bands/the number of layers supported simultaneously with D2D and a non-CA band/the number of layers supported simultaneously with D2D. In other words, SupportedBandCombination-r10 may include the combination of CA bands/the number of layers supported even when D2D is being performed and the non-CA band/the number of layers supported even when D2D is being performed. To be more specific, SupportedBandCombination-r10 does not include a combination of CA bands/the number of layers not supported simultaneously with D2D and a non-CA band/the number of layers not supported simultaneously with D2D.

In the second embodiment, RF-Parameters-r12 additionally includes information/parameter SupportedBandCombinationExt-r12. SupportedBandCombinationExt-r12 may include the combination of CA bands/the number of layers supported only when D2D is not being performed. SupportedBandCombinationExt-r12 may include the non-CA band/the number of layers supported only when D2D is not being performed.

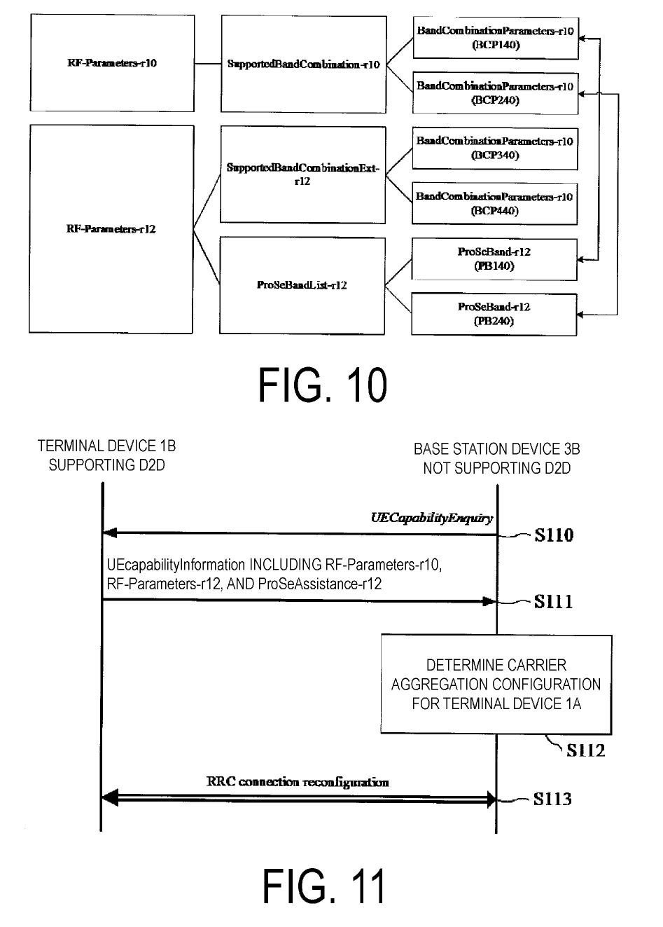

FIG. 10 is a diagram illustrating examples of RF-parameters-r10 and RF-Parameters-r12 according to the second embodiment. In FIG. 10, RF-parameters-r10 includes SupportedBandCombination-r10, and SupportedBandCombination-r10 includes two BandCobinationParameter-r10 (BCP140 and BCP240). Here, each of BandCobinationParameter-r10 (BCP140 and BCP240) indicates the combination of CA bands/the number of layers supported even when D2D is being performed or the non-CA band/the number of layers supported even when D2D is being performed. In other words, each of BandCobinationParameter-r10 (BCP140 and BCP240) may indicate the combination of CA bands/the non-CA band/the number of layers supported for the cellular link (each downlink and/or uplink) simultaneously with a D2D operation. To be more specific, each of BandCobinationParameter-r10 (BCP140 and BCP240) may indicate the combination of CA bands/the non-CA band/the number of layers supported when D2D transmission/reception is configured.

In FIG. 10, RF-Parameters-r12 includes SupportedBandCombinationExt-r12 and ProSeBandList-r12. In FIG. 10, SupportedBandCombinationExt-r12 includes two BandCobinationParameter-r10 (PB340 and PB440). Here, each of BandCobinationParameter-r10 (PB340 and PB440) indicates a CA band combination supported only when D2D is not being performed or a non-CA band supported only when D2D is not being performed. In other words, each of BandCobinationParameter-10 (PB340 and PB440) may indicate the combination of CA bands/the non-CA band/the number of layers not supported for the cellular link (each downlink and/or uplink) simultaneously with a D2D operation. To be more specific, each of BandCobinationParameter-r10 (PB340 and PB440) may indicate the combination of CA bands/the non-CA band/the number of layers supported when D2D transmission/reception is not configured.

In FIG. 10, ProSeBandList-r12 includes two ProSeBand-r12 (PB140 and PB240), the number of which is the same as the number of BandCobinationParameter-r10 included in SupportedBandCombination-r10. One ProSeBand-r12 corresponds to one BandCobinationParameter-r10. The order of ProSeBand-r12 is the same as the order of corresponding BandCobinationParameter-r10. In other words, PBX40 corresponds to BCPX40 (X=1 or 2). As described above, ProSeBand-r12 may include some or all of information (9) to information (14).

The base station device 3 can determine that BandCobinationParameter-r10 included in SupportedBandCombinationExt-r12 implicitly indicates the combination of CA bands/the number of layers supported only when D2D is not being performed or the non-CA band/the number of layers supported only when D2D is not being performed, which eliminates the need for ProSeBand-r12 corresponding to BandCobinationParameter-r10 included in SupportedBandCombinationExt-r12 to be included in ProSeBandList-r12. In this way, the information volume of UEcapabilityInformation can be reduced.

FIG. 11 is a sequence chart relating to transmission of UEcapabilityInformation according to the second embodiment.

A base station device 3B not supporting D2D transmits information/parameter UECapabilityEnquitry for requesting transmission of information/parameter UEcpabilityInformation, to the terminal device 1B supporting either or both of D2D communication and D2D discovery (S110).

The terminal device 1 that has received information/parameter UECapabilityEnquitry transmits UEcapabilityInformation including ProSeAssistance-r12, RF-Parameters-r10, and RF-parameters-r12, to the base station device 3 (S111). In accordance with RF-Parameters-r10 included in the received UEcapabilityInformation, the base station device 3 determines the configuration for carrier aggregation and/or spatial multiplexing for the terminal device 1 (S112). In accordance with the configuration determined in S112, the base station device 3 performs RRC connection reconfiguration for the terminal device 1 (S113).

The base station device 3B not supporting D2D ignores (unable to identify) SupportedBandCombinationExt-r12. Thus, the combination of CA bands/the number of layers supported only when D2D is not being performed and the non-CA band/the number of layers supported only when D2D is not being performed are not configured for the terminal device 1B supporting D2D. This causes the base station device 3B not supporting D2D to configure, in accordance with SupportedBandCombination-r10, the combination of CA bands/the number of layers supported even when D2D is being performed and the non-CA band/the number of layers supported even when D2D is being performed, for the terminal device 1B supporting D2D.

In accordance with SupportedBandCombinationExt-r12 (and/or ProSeBandList-r12), the base station device 3B supporting D2D may configure the combination of CA bands/the number of layers supported only when D2D is not being performed and the non-CA band/the number of layers supported only when D2D is not being performed, for the terminal device 1B supporting D2D and not performing D2D. In accordance with SupportedBandCombination-r10, the base station device 3B supporting D2D may configure the combination of CA bands/the number of layers supported even when D2D is being performed and the non-CA band/the number of layers supported even when D2D is being performed, for the terminal device 1B supporting D2D and performing D2D.

These processes allow the terminal device 1 to simultaneously perform D2D communication, D2D discovery and/or cellular communication efficiently. Moreover, these processes allow even the base station device 3 not supporting D2D to efficiently communicate with the terminal device 1 supporting D2D.

In the second embodiment, BandCobinationParameter-r10, indicating the combination of CA bands/the non-CA band/the number of layers supported when D2D is being performed in a certain band while not being supported when D2D is being performed in a band different from the certain band, may be included in SupportedBandCombinationExt-r12.

In this case, ProSeBand-r12 corresponding to BandCobinationParameter-r10 included in SupportedBandCombinationExt-r12 is needed. For this reason, in this case, ProSeBandList-r12 preferably includes ProSeBand-r12, the number of which is the same as the total of the number of BandCobinationParameter-r10 included in SupportedBandCombination-r10 and the number of BandCobinationParameter-r10 included in SupportedBandCombinationExt-r12, in ProSeBandList-r12.

Note that, in the first embodiment, BandCobinationParameter-r10 may be configured, SupportedBandCobination-r10 may be configured to indicate the combination of bands/the band/the number of layers supported even when D2D is being performed. In this case, in the first embodiment, when ProseBand-r12 includes information (12), information (13), and/or information (14) and when sidelink transmission/reception is not configured for the terminal device 1, the base station device 3 supporting D2D interprets the situation as the number of cells configurable for the cellular link increases by one in the band indicated by information (12), information (13), and/or information (14).

(1) The terminal device 1 according to the present embodiments is the terminal device 1 that performs transmission and/or reception in a link (sidelink) between terminal devices and includes a transmission unit that transmits first information (UEcapabilityInformation) to the base station device 3. The first information (UEcapabilityInformation) includes second information (SupportedBandCombination-r10) and third information (SupportedBandCombinationExt-r12). The second information (SupportedBandCombination-r10) indicates a band and/or a combination of bands that is supported only when transmission and/or reception is not being performed in the link between the terminal devices and that is to be used for communication with the base station device, and the third information (SupportedBandCombinationExt-r12) indicates a band and/or a combination of bands that is supported even when transmission and/or reception is being performed in the link between the terminal devices and that is to be used for communication with the base station device.

(2) In the present embodiments, the second information (SupportedBandCombination-r10) indicates the number of layers supported for spatial multiplexing in each of the bands indicated by the second information (SupportedBandCombination-r10), and the third information (SupportedBandCombinationExt-r12) indicates the number of layers supported for spatial multiplexing in each of the bands indicated by the third information (SupportedBandCombinationExt-r12).

(3) In the present embodiments, the third information (SupportedBandCombinationExt-r12) is not identified by the base station device 3 that is not capable of controlling transmission and/or reception in the link between the terminal devices.

(4) In the present embodiments, the first information (UEcapabilityInformation) includes fourth information (ProSeAssistance-r12), and the fourth information (ProSeAssistance-r12) includes some or all of the following information (A1) to information (A8).
Information (A1): information for requesting a resource for D2D transmission
Information (A2): information indicating a band/frequency for which a resource for D2D transmission is configured
Information (A3): information indicating whether there is an interest in D2D transmission
Information (A4): information indicating a band/frequency for which there is an interest in D2D transmission
Information (A5): information for requesting a resource for D2D reception/monitoring
Information (A6): information indicating a band/frequency for which a resource for D2D reception/monitoring is configured
Information (A7): information indicating whether there is an interest in D2D reception/monitoring
Information (A8): information indicating a band/frequency for which there is an interest in D2D reception/monitoring

(5) In the present embodiments, the first information (UEcapabilityInformation) includes fifth information (ProSeBand-r12) corresponding to each of the bands and/or the combinations of bands indicated by the second information (SupportedBandCombination-r10), and the fifth information (ProSeBandList-r12) includes some or all of the following information (B1) to information (B6).
Information (B1): information indicating that D2D is possible when the corresponding band or combination of bands is configured for communication with the base station
Information (B2): information indicating that D2D transmission is possible when the corresponding band or combination of bands is configured for communication with the base station
Information (B3): information indicating that D2D reception is possible when the corresponding band or combination of bands is configured for communication with the base station
Information (B4): information indicating a band/frequency in which D2D is possible when the corresponding band or combination of bands is configured for communication with the base station
Information (B5): information indicating a band/frequency in which D2D transmission is possible when the corresponding band or combination of bands is configured for communication with the base station
Information (B6): information indicating a band/frequency in which D2D reception is possible when the corresponding band or combination of bands is configured for communication with the base station

(6) In the present embodiments, the first information (UEcapabilityInformation) does not include fifth information (ProSeBand-r12) corresponding to each of the band and/or the combination of bands indicated by the third information (SupportedBandCombinationExt-r12).

(7) The base station device 3 of the present embodiments includes a reception unit receiving the first information.

A program running on each of the base station device 3 and the terminal device 1 according to the present invention may be a program that controls a central processing unit (CPU) and the like (a program for causing a computer to operate) in such a manner as to realize the functions according to the above-described embodiments of the present invention. The information handled in these devices is temporarily stored in a random access memory (RAM) while being processed. Thereafter, the information is stored in various types of read only memory (ROM) such as a flash ROM and a hard disk drive (HDD) and when necessary, is read by the CPU to be modified or rewritten.

Moreover, the terminal device 1 and the base station device 3 according to the above-described embodiments may be partially realized by the computer. This configuration may be realized by recording a program for realizing such control functions on a computer-readable medium and causing a computer system to read the program recorded on the recording medium for execution.

Moreover, the “computer system” here is defined as a computer system built into the terminal device 1 or the base station device 3, and the computer system includes an OS and hardware components such as a peripheral device. Furthermore, the “computer-readable recording medium” refers to a portable medium such as a flexible disk, a magneto-optical disk, a ROM, and a CD-ROM, and a storage device such as a hard disk built into the computer system.

Moreover, the “computer-readable recording medium” may include a medium that dynamically retains the program for a short period of time, such as a communication line that is used to transmit the program over a network such as the Internet or over a communication circuit such as a telephone circuit, and a medium that retains, in that case, the program for a fixed period of time, such as a volatile memory within the computer system which functions as a server or a client. Furthermore, the program may be configured to realize some of the functions described above, and additionally may be configured to be capable of realizing the functions described above in combination with a program already recorded in the computer system.

Furthermore, the base station device 3 according to the above-described embodiments can be realized as an aggregation (a device group) constituted of a plurality of devices. Devices constituting the device group may be each equipped with some or all portions of each function or each functional block of the base station device 3 according to the above-described embodiments. It is only required that the device group itself include general functions or general functional blocks of the base station device 3. Furthermore, the terminal device 1 according to the above-described embodiments can also communicate with the base station device as the aggregation.

Furthermore, the base station device 3 according to the above-described embodiments may be an Evolved Universal Terrestrial Radio Access Network (EUTRAN). Furthermore, the base station device 3 according to the above-described embodiments may have some or all portions of the function of a node higher than an eNodeB.

Furthermore, some or all portions of each of the terminal device 1 and the base station device 3 according to the above-described embodiments may be realized as an LSI that is a typical integrated circuit or may be realized as a chip set. The functional blocks of each of the terminal device 1 and the base station device 3 may be individually realized as a chip, or some or all of the functional blocks may be integrated into a chip. Furthermore, a circuit integration technique is not limited to the LSI, and the integrated circuit may be realized with a dedicated circuit or a general-purpose processor. Furthermore, if with advances in semiconductor technology, a circuit integration technology with which an LSI is replaced appears, it is also possible to use an integrated circuit based on the technology.

Furthermore, according to the above-described embodiments, the terminal device is described as one example of a communication device, but the present invention is not limited to this, and can be applied to a fixed-type electronic apparatus installed indoors or outdoors, or a stationary-type electronic apparatus, for example, a terminal device or a communication device, such as an audio-video (AV) apparatus, a kitchen apparatus, a cleaning or washing machine, an air-conditioning apparatus, office equipment, a vending machine, and other household apparatuses.

The embodiments of the present invention has been described in detail above referring to the drawings, but the specific configuration is not limited to the embodiments and includes, for example, an amendment to a design that falls within the scope that does not depart from the gist of the present invention. Furthermore, various modifications are possible within the scope of the present invention defined by claims, and embodiments that are made by suitably combining technical means disclosed according to the different embodiments are also included in the technical scope of the present invention. Furthermore, a configuration in which a constituent element that achieves the same effect is substituted for the one that is described according to the embodiments is also included in the technical scope of the present invention.

### INDUSTRIAL APPLICABILITY

An aspect of the present invention can be applied to, for example, a terminal device necessary to perform D2D efficiently.

### DESCRIPTION OF REFERENCE NUMERALS

1 (1A, 1B, 1C) Terminal device
3 (3A, 3B) Base station device
10 Radio transmission/reception unit
11 Antenna unit
12 RF unit
13 Baseband unit
14 Higher layer processing unit
15 D2D control unit
16 Radio resource control unit
30 Radio transmission/reception unit
31 Antenna unit
32 RF unit
33 Baseband unit
34 Higher layer processing unit
35 D2D control unit
36 Radio resource control unit

1. A terminal device performing transmission and/or reception in a link between terminal devices, the terminal device comprising a transmission unit transmitting first information to a base station device,
the first information including second and third information,
the second information indicating a band and/or a combination of bands that is supported only when transmission and/or reception is not being performed in the link between the terminal devices and that is used for communication with the base station device, and
the third information indicating a band and/or a combination of bands that is supported even when transmission and/or reception is being performed in the link between the terminal devices and that is used for communication with the base station device.

2. The terminal device according to claim 1, wherein
the second information indicates a number of layers supported for spatial multiplexing in each of the bands indicated by the second information, and
the third information indicates a number of layers supported for spatial multiplexing in each of the bands indicated by the third information.

3. The terminal device according to claim 1, wherein the third information is not recognized by a base station device that is not capable of controlling transmission and/or reception in a link between terminal devices.

4. The terminal device according to claim 1, wherein
the first information includes fourth information, and
the fourth information includes some or all of the following information (A1) to information (A8):
Information (A1): information for requesting a resource for D2D transmission;
Information (A2): information indicating a band/frequency for which a resource for D2D transmission is configured;
Information (A3): information indicating whether there is an interest in D2D transmission;
Information (A4): information indicating a band/frequency for which there is an interest in D2D transmission;
Information (A5): information for requesting a resource for D2D reception/monitoring;
Information (A6): information indicating a band/frequency for which a resource for D2D reception/monitoring is configured;
Information (A7): information indicating whether there is an interest in D2D reception/monitoring;
Information (A8): information indicating a band/frequency for which there is an interest in D2D reception/monitoring.

5. The terminal device according to claim 1, wherein
the first information includes fifth information corresponding to each of the bands and/or the combinations of bands indicated by the second information, and
the fifth information includes some or all of the following information (B1) to information (B6):
Information (B1): information indicating that D2D is possible when the corresponding band or combination of bands is configured for communication with the base station;
Information (B2): information indicating that D2D transmission is possible when the corresponding band or combination of bands is configured for communication with the base station;
Information (B3): information indicating that D2D reception is possible when the corresponding band or combination of bands is configured for communication with the base station;
Information (B4): information indicating a band/frequency in which D2D is possible when the corresponding band or combination of bands is configured for communication with the base station;
Information (B5): information indicating a band/frequency in which D2D transmission is possible when the corresponding band or combination of bands is configured for communication with the base station;
Information (B6): information indicating a band/frequency in which D2D reception is possible when the corresponding band or combination of bands is configured for communication with the base station.

6. The terminal device according to claim 5, wherein the first information does not include the fifth information corresponding to each of the bands and/or the combinations of bands indicated by the third information.

7. An integrated circuit mounted on a terminal device performing transmission and/or reception in a link between terminal devices,
the integrated circuit causing the terminal device to perform a series of functions including the function of transmitting first information to a base station device,
the first information including second information and third information,
the second information indicating a band and/or a combination of bands that is supported only when transmission and/or reception is not being performed in the link between the terminal devices and that is used for communication with the base station device, and
the third information indicating a band and/or a combination of bands that is supported even when transmission and/or reception is being performed in the link between the terminal devices and that is used for communication with the base station device.

8. A communication method used by a terminal device performing transmission and/or reception in a link between terminal devices, the communication method comprising the step of transmitting first information to a base station device,
the first information including second information and third information, the second information indicating a band and/or a combination of bands that is supported only when transmission and/or reception is not being performed in the link between the terminal devices and that is used for communication with the base station device, and
the third information indicating a band and/or a combination of bands that is supported even when transmission and/or reception is being performed in the link between the terminal devices and that is used for communication with the base station device.

9. A base station device communicating with a terminal device performing transmission and/or reception in a link between terminal devices, the base station device comprising a reception unit receiving first information from the terminal device,
the first information including second information and third information,
the second information indicating a band and/or a combination of bands that is supported only when transmission and/or reception is not being performed in the link between the terminal devices and that is used for communication with the base station device, and
the third information indicating a band and/or a combination of bands that is supported even when transmission and/or reception is being performed in the link between the terminal devices and that is used for communication with the base station device.

10. The base station device according to claim 9, wherein
the second information indicates a number of layers supported for spatial
multiplexing in each of the bands indicated by the second information, and
the third information indicates a number of layers supported for spatial multiplexing in each of the bands indicated by the third information.

11. The base station device according to claim 9, wherein the third information is not recognized by a base station device that is not capable of controlling transmission and/or reception in a link between terminal devices.

12. The base station device according to claim 9, wherein
the third information includes fourth information, and
the fourth information includes some or all of the following information (A1) to information (A8):
Information (A1): information for requesting a resource for D2D transmission;
Information (A2): information indicating a band/frequency for which a resource for D2D transmission is configured;
Information (A3): information indicating whether there is an interest in D2D transmission;
Information (A4): information indicating a band/frequency for which there is an interest in D2D transmission;
Information (A5): information for requesting a resource for D2D reception/monitoring;
Information (A6): information indicating a band/frequency for which a resource for D2D reception/monitoring is configured;
Information (A7): information indicating whether there is an interest in D2D reception/monitoring;
Information (A8): information indicating a band/frequency for which there is an interest in D2D reception/monitoring.

13. The base station device according to claim 9, wherein
the first information includes fifth information corresponding to each of the bands and/or the combinations of bands indicated by the second information, and
the fifth information includes some or all of the following information (B1) to information (B6):
Information (B1): information indicating that D2D is possible when the corresponding band or combination of bands is configured for communication with the base station;
Information (B2): information indicating that D2D transmission is possible when the corresponding band or combination of bands is configured for communication with the base station;
Information (B3): information indicating that D2D reception is possible when the corresponding band or combination of bands is configured for communication with the base station;
Information (B4): information indicating a band/frequency in which D2D is possible when the corresponding band or combination of bands is configured for communication with the base station;
Information (B5): information indicating a band/frequency in which D2D transmission is possible when the corresponding band or combination of bands is configured for communication with the base station;
Information (B6): information indicating a band/frequency in which D2D reception is possible when the corresponding band or combination of bands is configured for communication with the base station.

14. The base station device according to claim 13, wherein the first information does not include the fifth information corresponding to each of the bands and/or the combinations of bands indicated by the third information.

15. An integrated circuit mounted on a base station device communicating with a terminal device performing transmission and/or reception in a link between terminal devices, the integrated circuit causing the base station device to perform a series of functions including the function of receiving first information from the terminal device,
the first information including second information and third information,
the second information indicating a band and/or a combination of bands that is supported only when transmission and/or reception is not being performed in the link between the terminal devices and that is used for communication with the base station device, and
the third information indicating a band and/or a combination of bands that is supported even when transmission and/or reception is being performed in the link between the terminal devices and that is used for communication with the base station device.

16. A communication method used by a base station device communicating with a terminal device performing transmission and/or reception in a link between terminal devices, the communication method comprising the step of receiving first information from the terminal device,
the first information including second information and third information,
the second information indicating a band and/or a combination of bands that is supported only when transmission and/or reception is not being performed in the link between the terminal devices and that is used for communication with the base station device, and
the third information indicating a band and/or a combination of bands that is supported even when transmission and/or reception is being performed in the link between the terminal devices and that is used for communication with the base station device.
